(19) United States
(12) Patent Application Publication
(10) Pub. No.: US 2008/0223506 A1
(43) Pub. Date: Sep. 18, 2008

(54) METHOD OF COLOUR REFURBISHING METAL DISPLAY FIXTURES

(75) Inventors: Jack FIFE, Edmonton (CA); Garvin WEBER, Sherwood Park (CA); Brian SMITH, Leduc (CA)

Correspondence Address: DAVIS BUJOLD & Daniels, P.L.L.C., 112 PLEASANT STREET, CONCORD, NH, 03301, US

(73) Assignee: VENGER GROUP, Leduc (CA)

(21) Appl. No.: 12/047,088

(22) Filed: Mar. 12, 2008

Related U.S. Application Data
(60) Provisional application No. 60/906,652, filed on Mar. 13, 2007.

(30) Foreign Application Priority Data
Mar. 12, 2007 (CA) 2581600

(51) Int. Cl. B32B 43/00

(52) U.S. Cl. 156/94

(57) ABSTRACT

A method of colour refurbishing metal display fixtures. A first step involves printing on a display film an image of a desired colour finish. A second step involves securing the display film to components of a metal display fixture

### FIELD

The present invention relates to a method of colour refurbishing metal display fixtures.

### BACKGROUND

Stores are periodically renovated. When those renovations involve the implementation of a new colour scheme, metal display fixtures in the store must be refurbished in a colour that complements the new colour scheme. At the present time all non-removable components are recoated either through a powder coating or electro-static painting process. All removable and replaceable components are either removed for recoating or replaced with components of the correct colour. More often than not, components that are not of the desired colour are hauled away for disposal.

### SUMMARY

There is provided a method of colour refurbishing metal display fixtures. A first step involves printing on a display film an image of a desired colour finish. A second step involves securing the display film to components of a metal display fixture.

### BRIEF DESCRIPTION OF THE DRAWINGS

These and other features will become more apparent from the following description in which reference is made to the appended drawings, the drawings are for the purpose of illustration only and are not intended to in any way limit the scope of the invention to the particular embodiment or embodiments shown, wherein:

FIG. 1 is a perspective view of a display film being applied to a display fixture.

### DETAILED DESCRIPTION

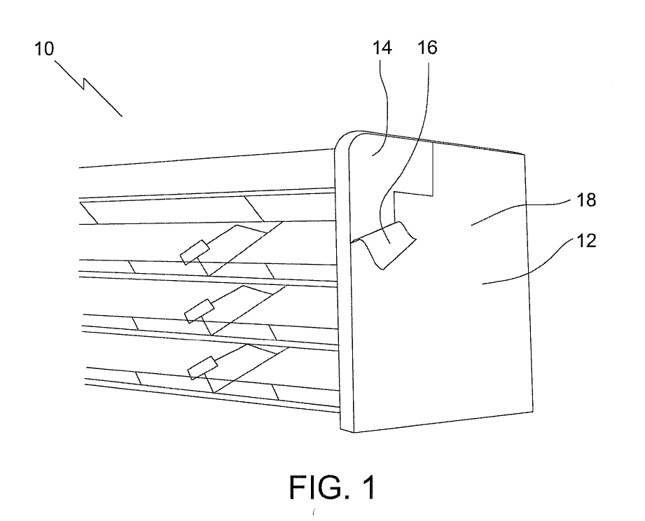

A method of colour refurbishing metal display fixtures generally identified by reference numeral 10, will now be described with reference to FIG. 1.

Structure and Relationship of Parts:

Referring to FIG. 1, a metal display fixture 10 to be colour refurbished is provided. A display film 12 is being secured to a surface 14 of metal display fixture 10. Display film 12 has an adhesive side 16 and a display side 18. Display film 12 may be a polycarbonate film or polyethylene film, although it will be appreciated that display film 12 may be constructed out of other suitable materials. Display side 18 of display film 12 has an image of a desired colour finish printed on its surface area. Adhesive side 16 is adapted to adhere to any surface area by means of an adhesive. Adhesive side 16 adheres to surface 14, securing display film 12 to surface 14.

Operation:

Referring to FIG. 1, a method of colour refurbishing metal display fixture 10 includes printing a desired colour finish onto display side 18 of display film 12. This printing may be done using a print press, although other suitable methods of printing may be used instead. Alternatively, a design may be printed on display film 12 instead of simply a different colour. An adhesive is applied to adhesive side 16 of display film 12, and adhesive side 16 is applied to surface 14 of display fixture 10. This may be done using strips (as shown in FIG. 1) or properly fitted pieces (not shown) of display film 12. By applying adhesive side 16 of display film 12 to surface 14, display film 12 is secured to display fixture 10. This allows a user to completely refurbish any display unit that requires refurbishing to alter its colour, change textures or update old styles. One of the advantages of using display film 12 instead of traditional methods, such as spray painting or powder coating, is that no spraying is required on site. Traditional methods of refurbishing, such as spray painting or powder-coating, usually release dangerous volatile organic compounds into the air, and therefore are not desirable to use in a store. In addition, display film 12 allows components to be updated, instead of replaced. This saves a user the cost of replacing components that, apart from their colour, are perfectly serviceable. Furthermore, display film 12 is more durable than finishes that come from traditional methods, such as spray painting or powder coating. Although an end of a metal display fixture has been chosen for illustration, it will be appreciated that the same method is being used to refurbish the canopy, the tank and all other components of the tank, both removable and non-removable, that are visible to the consumer.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiments without departing from scope of the Claims.

What is claimed is:

1. A method of colour refurbishing metal display fixtures, comprising the steps of:
printing on a display film an image of a desired colour finish; and
securing the display film to components of a metal display fixture.

2. The method as defined in claim 1, the display film being a polycarbonate display film.

3. The method as defined in claim 1, the display film being secured by means of adhesive.
